(19) United States
(12) Patent Application Publication
(10) Pub. No.: US 2022/0009265 A1
(43) Pub. Date: Jan. 13, 2022

(54) CUSTOMIZED BOOK WITH INTERACTIVE CHARACTER AND PROCESS OF ACQUISITION OF THE BOOK WITH INTERACTIVE CHARACTER

(71) Applicant: EDITORA DENTRO DA HISTÓRIA LTDA ? EPP, Campinas (BR)

(72) Inventors: André OLIVEIRA, Campinas (BR); Flávio MOREIRA, Campinas (BR); Diego MORAES, Campinas (BR); Felipe PANIAGO, Campinas (BR); Alexandre ITO, Campinas (BR)

(21) Appl. No.: 17/293,290

(22) PCT Filed: Dec. 2, 2019
(86) PCT No.: PCT/BR2019/050514

§ 371 Date: May 12, 2021

(30) Foreign Application Priority Data
Dec. 11, 2018 (BR) 10 2018 075746 6

(51) Int. Cl. B42D 1/00; G06F 40/166

(52) U.S. Cl. CPC B42D 1/00; B42P 2261/00; G06F 40/166

(57) ABSTRACT

This invention comprises a customized book (1) preferably in hardcover that is obtained through a sequential process developed using a specific software application, in which the user, usually but not necessarily a child, visits a website on which several settings are offered for the user to literally set up their character, such as: skin color, race, eye color, glasses, clothes, type of shoes, anyway, several parameters can be set for that specific interaction, which are obviously variable as desired. Once the character is chosen and set up, with all registered settings, the system generates an avatar (2), which is transferred into the book through a software application. Thus, the previously chosen book, with preferably famous characters, receives in an interactive manner the avatar (2) chosen to take part in the story, which arouses in the child an extremely pleasant feeling, as well as in their parents and other adult people.

### FIELD OF THE INVENTION

This Invention patent application comprises a book with an interactive character, as well as the process of acquisition of that book, with the field of application of the invention encompassing the segment of children's and adult bookstores and entertainment.

### BACKGROUND OF THE INVENTION

A very appropriate example when we talk about this invention is the children's market; however, it must be noted that the adult universe, too, may benefit from its application.

Following the line of the children's universe, particularly in these days, when the information technology rules over people's resources, time, and thoughts, one has to agree that, especially for children, it is not advisable to spend all the time looking at a smartphone, a tablet, or similar item, leaving behind other, more ludic activities, which are as important as technological activities for children.

Following this train of thought, the inventor, seeking to arouse the children's interest in more ludic and cultural activities, has developed the book in this invention, which can, in one possible embodiment, contain known children's characters, so that, through the process of creating said book, the child can insert a character with features set by himself/herself, who will interact in the story with the famous characters.

### STATE OF THE ART

Interactive activities are more and more intensive these days, ranging from memory games, video games, and others to network-based interactive action, as is the case with modern electronic and entertainment devices.

However, it is desirable for children, in particular, to be in contact with traditional means of reading and/or interaction with images, which becomes extremely intensified when it bears a direct relation to idols and preferred characters, and others.

Other forms of interactivity are present in the state of the art, such as the one provided in document PI0705201-4, deposited on Oct. 1, 2007 and published on May 26, 2009, titled “SISTEMA INTERATIVO DE ENTRETENIMENTO E ENSINO”, which describes an interactive entertainment and education system used as entertainment and education of children that includes a character associated with a device with computer capacity and an interactive entertainment process therein installed. Said character comprises a loudspeaker installed to their body, audio input and output, microphone, and a camera, which, when added to said device, works as a loudspeaker. The process is installed to the device so that the instructions in each stage are emitted by the character's loudspeaker, providing an interaction among all components of the system. That system employs interactivity with a character, however, it employs a computer device in which the character makes use of a loudspeaker installed to their body.

### THE INVENTION

This invention comprises a book preferably in hardcover that is obtained through a sequential process developed using a specific software application, in which the user, usually but not necessarily a child, visits a website on which several settings are offered for the user to literally set up their character, such as: skin color, race, eye color, glasses, clothes, type of shoes, anyway, several parameters can be set for that specific interaction, which are obviously variable as desired.

Once the character is chosen and set up, with all registered settings, the system generates an avatar, which is transferred into the book through a software application. Thus, the previously chosen book, with preferably famous characters, receives in an interactive manner the avatar chosen to take part in the story, which arouses in the child an extremely pleasant feeling, as well as in their parents and other adult people.

A great advantage of the invention, in connection with the book acquisition process, lies in the fact that, upon choosing their avatar and entering it in the desired book, the latter can be printed on site or sent by mail.

The invention can further be used by an infinite amount of users, in several segments of normal life. For instance, they can create an avatar associated with their favorite team, an event or party that was thrown, a tour site, anyway, this is a technology that is not limited to an age group and will generate a book to be kept or exposed at home, at work, or in other places, telling a story in which the avatar is the user themselves.

The customized book to which the invention refers will be printed from a software application developed to operate on a website, where the settings desired by the user are entered to create the avatar that will take part in an interactive manner with the other characters in the story.

For that purpose, the customized book is acquired from a process comprising the following sequential stages:
Acquisition of the book settings;
Acquisition of the customization done by the client;
Acquisition of the .html file;
Conversion of the .html file into images;
Grouping of the images into PDF files;
Uploading to a cloud solution;
Downloading and printing.

### Advantages of the Invention

In addition to the advantages made evident in the preceding description, the following advantages can also be found:
A customized, preferably hardcover book is acquired nearly in real time, in which the avatar created by the user interacts in the story with other characters, preferably famous;
It can be used by children, adult, and people from any age group to create stories or passages associated with movies, clubs, places, trips, events, parties, and other situations that one might wish to record in the form of a customized book;
Low execution cost;
Extremely easy to set up the avatar, which can be done on the website through the software application developed;
The customized book can be prepared on site or requested via the website and sent by mail;
The customized book according to the invention enables the user to dive into any stories, interacting with characters of their choice.

### DESCRIPTION OF THE DRAWINGS

The invention will be described below in one possible embodiment, and, for better understanding, references will be made to the attached drawings, in which they are represented:

FIG. 1: Perspective view of the customized book according to the invention, with random pictures and the avatar highlighted;

FIG. 2: Perspective view of the customized book according to the invention, in an open position, with random pictures and the avatar highlighted;

FIG. 3: Schematic diagram showing the computerized process of acquisition of the customized book to be sent for downloading and printing.

### DETAILED DESCRIPTION OF THE INVENTION

The CUSTOMIZED BOOK WITH INTERACTIVE CHARACTER AND PROCESS OF ACQUISITION OF THE BOOK WITH INTERACTIVE CHARACTER, which is the subject matter of this Invention patent application, comprises a customized book (1) that is preferably in hard cover, containing a character in the form of an avatar (2), who interacts in a story with famous characters, based on the parameters defined for this avatar (2) by the user themselves, who can be either a child or an adult; the avatar (2) is customized on a website, based on a software application employed in the process of acquisition of the customized book (1).

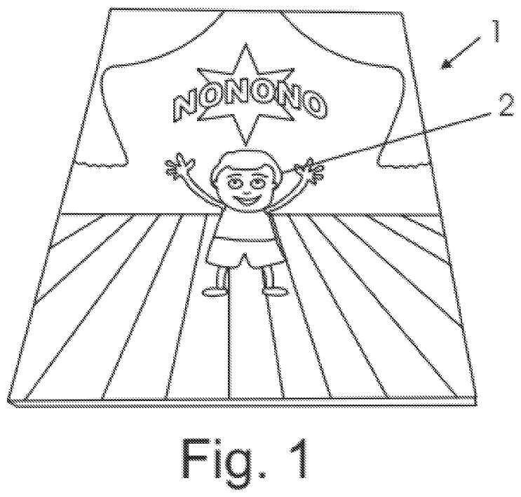

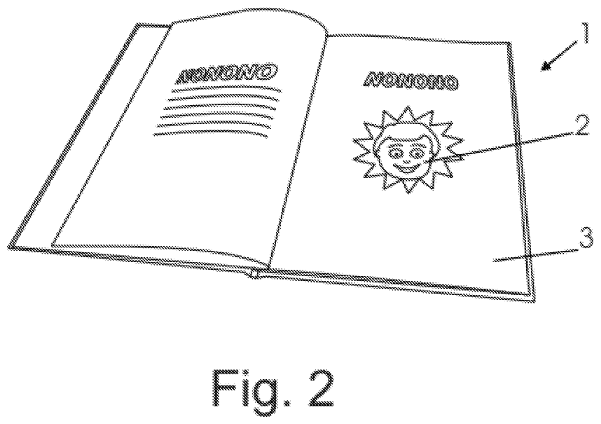

As shown in FIGS. 1 and 2, the customized book (1) is preferably in hardcover, whereas the intermediate pages (3) develop the story sequence, with the avatar (2)—chosen and defined by the user—interacting with the other characters, through images and texts according to the layout and colors adopted.

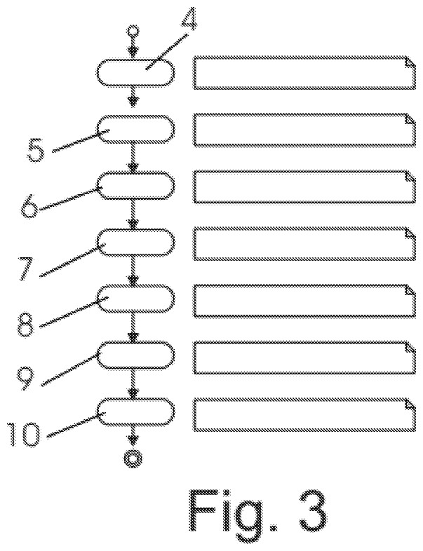

As shown in FIG. 3, the process of acquisition of the customized book (1) includes the following stages:
Acquisition of the book settings (4): at this stage, all settings of the book are acquired through the “builder” system (images, character, texts, sources, positioning, and alignment of components);
Acquisition of the customization done by the user (5): at this stage, the customization that the user did upon the purchase (e.g. child's name, clothes, hair, eye color, etc.) is acquired;
Creation of an html file (6): based on the product settings (which may vary within a defined universe) and the user's customization, an .html file is generated for each page of the book;
.html file conversion into images (7): at this stage, each .html file is converted into a corresponding high-resolution image (in a jpg format) through the PhantomJS component;
Image grouping into PDF files (8): at this stage, the images are grouped into at least three PDF files (cover, endpaper, and book block). The iTextsharp component is used to generate the PDF files;
Cloud uploading (9): at this stage, the PDF files are stored in a cloud storage solution such as Amazon AWS;
Downloading and printing (10): at this stage, the publishing house will download the PDF files and start printing them.

In detail, the invention uses the Web Builder system, where the whole structure to generate customized books is registered. That is, the structure is ready on the website, so that the user can access it and generate their desired characteristics for the character, in order to finally configure their avatar (2).

Thus, the customized book (1) is generated page by page (PNG, JPG, and others), working with multiple layers. Once the configuration is done, all layers and images are consolidated into a single .html file, assembling the book pages.

Once this is done, the .html file is turned into a JPG image, a high-resolution image generated for each page.

In order that the publishing house can print the customized book (1) more quickly, all pages are grouped, as described in the diagram of FIG. 3, so as to generate at least three PDF files. This is so because the preferably hard cover needs a specific PDF file, the same applying to the endpaper, whereas the book block, where the pages are, comprises another PDF.

The technology of this invention thus enables the publishing house in charge to, as the PDF files are on the cloud, download and print them as per its own technology.

Therefore, in case the client once again wishes another printout of the same book, all they need to do is go to the website and place a request, and the publishing house automatically receives it and performs the printing again.

The printing can be done even immediately, for instance, at events, where the user will do all the customization and generate the avatar (2) and the whole process will carry on so that, at the end, the printing office there will do the printing.

In a website request process, with a time to delivery to the end consumer, the delivery to said consumer takes in average around 48 hours, with a pedagogical activities guide sent along with the customized book (1).

1) CUSTOMIZED BOOK WITH INTERACTIVE CHARACTER, which comprises a customized book (1) that is preferably in hardcover, wherein a character in the form of an avatar (2) interacts in a story with famous characters, based on the parameters defined for this avatar (2) by the user themselves, who can be either a child or an adult; the avatar (2) is customized on a website, based on a software application employed in the process of acquisition of the customized book (1).

2) CUSTOMIZED BOOK WITH INTERACTIVE CHARACTER, as per claim 1, wherein the customized book (1) is preferably in hardcover, whereas the intermediate pages (3) develop the story sequence, with the avatar (2)—chosen and defined by the user—interacting with the other characters, through images and texts according to the layout and colors adopted.

3) PROCESS OF ACQUISITION OF THE BOOK WITH INTERACTIVE CHARACTER, to acquire the customized book (1) described in claims 1 and 2, wherein the relevant process of acquisition of the customized book (1) includes the following stages:
Acquisition of the book settings (4): at this stage, all settings of the book are acquired through the “builder” system—images, character, texts, sources, positioning, and alignment of components;
Acquisition of the customization done by the user (5): at this stage, the customization that the user did upon the purchase is acquired;
Creation of an .html file (6): based on the product settings and the users customization, an .html file is generated for each page of the book;
.html file conversion into images (7): at this stage, each .html file is converted into a corresponding high-resolution image (in a jpg format) through the PhantomJS component;
Image grouping into PDF files (8): at this stage, the images are grouped into at least three PDF files using the iTextsharp component to generate the PDF files;
Cloud uploading (9): at this stage, the PDF files are stored in a cloud storage solution such as Amazon AWS;
Downloading and printing (10): at this stage, the publishing house will download the PDF files and start printing them.
